(19) United States
(12) Patent Application Publication
(10) Pub. No.: US 2009/0320297 A1
(43) Pub. Date: Dec. 31, 2009

(54) GRIP

(75) Inventors: Leonardus Hendrikus Gerardus Johannes Segeren, Drachten (NL); Paul Johan Teuben, Drachten (NL); Lammert Jan Brouwer, Drachten (NL); Corneulis Willem Roth, Emmen (NL); Jakob Heier, Zuerich (CH); Jacob Smid, Drachten (NL); Johannes Bernardus Valentinus Opzeeland, Dronten (NL); Michel Bleeker, Groningen (NL); Hubert Petz, Drachten (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/158,754

(22) PCT Filed: Dec. 15, 2006
(86) PCT No.: PCT/IB06/54888

§ 371 Date: Jun. 23, 2008

(30) Foreign Application Priority Data
Dec. 22, 2005 (EP) 05112819.7

(51) Int. Cl. B26B 19/28; B26B 21/40; B23P 17/04

(52) U.S. Cl. 30/45; 30/537; 29/428

(57) ABSTRACT

The grip (1) according to the invention has a rigid frame (3) for providing a dedicated shape, which allows manufacturing complex three-dimensional shapes. The grip further comprises a flexible skin (5) having an outer surface and being attached to the frame at its periphery, a lid being attached to the frame at its periphery and a chamber being enclosed by the skin and the lid, and substantially filled with a formable material. These features enable an optional design freedom in the shape of the grip. This invention also relates to a method of manufacturing the grip.

The invention relates to a grip, an appliance comprising a grip, an electric shaver comprising a grip and a method of manufacturing a grip.

Many appliances are provided with grip elements trying to provide the user a soft-touch, rubber-like feel, accompanied with a certain anti-slip behaviour. In US patent publication 2003/0123917 a deformable sleeve is described for attachment to various products for use as a grip or to provide a stylish appearance. The deformable sleeve is provided with two membranes that define a cavity filled with a formable material. A patch and a sleeve-type configuration are applied.

It is an object of the invention to provide an optimal design freedom in the shape of a grip.

This object is achieved by the grip according to the invention having a rigid frame, a flexible skin having an outer surface and being attached to the frame at its periphery, a lid being attached to the frame at its periphery and a chamber being enclosed by the skin and the lid and substantially filled with a formable material.

The grip according to the invention has a rigid frame for providing a dedicated shape, which allows to manufacture complex three-dimensional shapes including a twisted, a torsion, a concave and a convex shape. The properties of the grip according to the invention can be designed independent of the appliance that it is intended for, this offers greater design freedom for the apparatus.

The rigidity provided by the frame further offers freedom of choice for the material selected for the skin and lid. These can be of a flexible material while the basic shape of the grip is being retained by the frame. The frame of the grip may have a periphery shaped to fit a corresponding a recess in a domestic appliance.

The grip according to the invention can be designed such that it fits the user best for the task at hand; optimize the shape of the grip to a part of the hand that is in contact with the grip if the hand grasps the grip; this may be the fingers as whole, fingertips, palm of the hand or combinations thereof.

The frame provides the flexibility to design complex shapes which allow for a delicate control over the appliance. For instance if the grip according to the invention is applied to a shaver, during shaving the user wants to steer the shaving head of the shaver to predetermined places. A good control over the appliance is therefore required. The flexibility in design of the shape of the grip allows for a shape providing the steering desired.

The grip has a frame having an outer rim defining a frame periphery, therefore the grip can easily be picked up and positioned at a desired position on an apparatus by a person or a robot assembling an appliance. This way a grip according to the invention provides easy mounting on or to an appliance. The appliance requires limited requirements to receive the grip because the grip has a structure of its own.

The frame further provides a sturdiness and strength to the grip. If the formable material is being pressed by the user, this material will to some extent bump against the frame. In this situation the firmness of the frame provides a counter force and dimensional stability to the grip. The designed frame periphery is being kept during use.

The grip according to the invention is ready for use. The grip may be designed as a component that constitutes part of the housing. The grip according to the invention can be exchanged by for instance a firmer or softer grip. This provides flexibility to exchange the grip according to taste; the user may personalize an apparatus provided with a grip.

The rigid frame is made from a material that gives the grip a stiffness to handle during/after manufacturing. The frame may contain a fixing means to attach the frame to the housing. For the frame any rigid material is possible. Examples are plastics or metals. A more specific example is a transparent, light conducting plastic. Preferred choices are glass filled polyamide or glass filled polypropylene.

A domestic and personal care apparatus has a tactile interaction with the user during handling. The skin and the formable material together are referred to as the formable body of the grip. The formable body of the grip according to the invention will deform in accordance with an anatomical contour of a hand of the user. An ergonomic grip improves the interaction with the apparatus, resulting in enhanced comfort for and control by the user. The skin and the formable material in the grip will be deformed after the customer applies a certain force, forming an indent or groove. After the customer releases the grip, the skin and the formable material will return—or relax—in its original position after some time in a visco-elastic (time-dependent) behavior. The time-dependency of this ‘memory-effect’ can be adjusted in this invention by selecting a different material or material grade. The time to return back to the shape in rest is also referred to as recovery time.

Typically the grip according to the invention has a recovery time which is less than 5 seconds. In an embodiment of the grip according to the invention the grip has a shape that after being pressed returns back in the shape in 0.5-3.5 seconds after release of the grip, preferably it returns back in the shape in 1.5-2.5 seconds after release of the grip. Such a recovery time provides comfort while using the appliance due to relief of stress in the users hand and at the same time still allows control over the apparatus.

The formable material may be deformed elastically or by flow of the material with response to the applied pressure. The formable material can be selected from a variety of materials, such as any liquid, gel or solid. The formable material may be a viscous material or an elastic material or a visco-elastic material.

More specific, the formable material can be a viscous fluid or a viscous gel. Examples are silicone oils, silicone gels, polyurethane (PU) gels, highly viscous polymeric oils, or extremely soft thermoplastic elastomers.

Yet, soft materials like foams, more specifically visco-elastic foams, soft granular materials, light foams, sponge rubber gels or copolymers with high contents of plasticizing oils form a group of other possible formable material candidates.

In an embodiment of the grip according to the invention the formable material is a soft gel-like vulcanizate. One example is a silicone elastomer commonly known as room temperature vulcanizing silicone material (RTV).

A RTV-type fill material according to the invention does not fully cure to a rubber but remains a gel. Viscosity and hardness can be fine tuned via the degree of cross linking.

In another embodiment the formable material is a thermoplastic SEBS gel or a PU gel, wherein SEBS is short for Styrene-Ethylene-Butylene-Styrene based thermoplastic elastomer. The SEBS gel is a one-component gel, which makes dosing easier than a two-component gel such as the PU gel.

The grip according to any the invention comprises an at least partially cross-linked silicone rubber, a polyurethane gel, or a SEBS gel as formable material also mentioned as visco-elastic material.

Visco-elastic materials are typically characterized by two descriptive parameters. One parameter is used to describe energy storage (from the elastic part) and the other to describe energy loss (from the viscous part). A common pair of material parameters is the storage modulus G₁ and the loss modulus G₂.

In an embodiment of the grip according to the invention the formable material is visco-elastic material that has a storage modulus G₁ in a range of 1 kPa-100 kPa and a loss modulus G₂ in a range of 1 kPa-20 kPa.

In a practical embodiment the storage modulus G₁ is in a range of 10 kPa-60 kPa and a loss modulus G₂ in a range of 6 kPa-15 kPa. The G1 and G2 values are values at room temperature and at a strain amplitude of 1% at an angular frequency of ω=0.11/s. Measurements were performed on a modular compact rheometer MRC 300 from Physica.

An at least partially cured two-component silicone rubber is a preferred visco-elastic material in the chamber of the grip. Generally the silicone rubber will be fully cured. Silicone rubbers can be divided into systems cross linking at room temperature (RTV) and systems cross linking at higher temperatures, which can be processed via e.g. injection moulding. An example of the later is liquid silicone rubber (LSR), a two-component liquid rubber system that can be pumped into a suitable injection molding machine, then heat cured to produce molded rubber parts, also called LIM (liquid injection moulding). The differences between the systems are essentially in cross link density and polymer chain length and thus a viscosity of the polymer used and the content of reinforcing filler e.g. silica.

The formable material may comprise additives such as pigments, dyes, opacifiers, clarifiers etcetera.

An alternative visco-elastic material is a polyurethane (PU) gel. Polyurethane can be made in a variety of densities and hardnesses by varying the type of monomer(s) used and adding other substances to modify their characteristics, notably density, or enhance their performance. The main polyurethane-producing reaction is between a diisocyanate (aromatic and aliphatic types are available) and a poly(ethylene glycol) or polyester polyol, in the presence of a suitable catalyst and one or more additives.

In an embodiment of the grip according to the invention the flexible skin is made from a material selected from a group comprising silicone rubber, polyurethane and thermoplastic elastomer (TPE). Examples of suitable TPEs are a olefin based thermoplastic (TPO), a thermoplastic vulcanizate (TPE-V also called TPV; this is a rubber polyolefin blend), a styrene-based thermoplastic elastomer (TPE-S: a SEBS block copolymer or a SBS block copolymer), a polyurethane based thermoplastic elastomer (TPE-U also called TPU), a thermoplastic polyamide based elastomer (TPE-A) or a thermoplastic polyester based elastomer (TPE-E).

In an embodiment of the grip according to the invention the flexible skin material has a hardness in a range of 5 Shore A-80 Shore A, preferably 8 Shore A-40 Shore A.

Good results were obtained using Silopren® LSR 2740 TP 3783 from GE Bayer Silicones as material for the flexible skin, this LSR recipe comprises:

Component A: polydimethyl siloxane with vinyl groups and catalyst

Component B: polydimethyl siloxane with vinyl and Si—H groups The thickness of the flexible skin is preferably between 0.1 and 2 mm thick. Very good results have been obtained using a range for the thickness of the skin between 0.5 and 0.8 mm.

The skin made from a soft thermoplastic material, an elastomer, or a thermoplastic elastomer may tend to become sticky. The skin made from liquid silicone rubber tends to be less sticky and tends to have a lower susceptibility to dirt and a lower susceptibility to external media, such as shaver lotions, cleaning agents, iron additives, coffee, etcetera.

In order to modify the properties of an outer surface of the skin, the skin may be coated with an additional layer. The function of this layer is, for example, to lower the coefficient of friction of the skin or to reduce susceptibility for dust and dirt attraction or to provide additional protection against for example shaving additives, or to provide additional strength against tearing. A preferred combination is LSR Topcoat from GE Advanced Materials on a LSR skin.

A layer providing the user with information, such as one or more printed letters, numbers, indices, logo's etc., may be present on the outer surface of the skin.

The soft surface can be decorated with special inks for instance using pad printing.

Logo's and other information or decoration effects may be expressed via the lid. In an embodiment of the grip according to the invention the skin and deformable material are transparent or translucent and the side of lid facing the formable material is provided with an information or decoration layer. This layer may be a print or a foil.

This way a certain dome effect may be generated. The lid may further have a function as static or active display.

Silopren® LSR 2730 TP3823 from GE Bayer Silicones (hardness ca. 30 Shore A), SEBS Cawiton PR2677 (ca. 20 Shore A) and SEBS Cawiton® PR4550 from Wittenburg B.V. (ca. 15 Shore A) are preferred materials for the skin.

Antibacterial agents may be incorporated in the grip, either as coating or bulk agents.

The lid at the backside of the panel may be made such that it provides a watertight chamber. This is especially of relevance in case of liquid fill material. Panel and lid must be tightly sealed to prevent that uncured gel or not fully cured fill material leaks out of the grip during processing (<100° C.).

The lid further holds the counter-pressure to achieve a defined grip and feel when the customer deforms the skin layer. Several joining technologies were assessed and the technologies snapping and press fit were assessed as most suitable for that purpose. An option is that the seal is also used to clamp the lid in the frame.

In case for instance a light source, such as LED, is present behind the grip, the lid, the formable material and the skin have to be transparent or translucent to some extent as to let the light radiate through the grip.

A foil providing decoration and/or information may be located in between the lid and the formable material. The lid may be covered with an optical effect film e.g. Multi-Lens film (Coburn) or optical diffraction grating film.

An embodiment of the grip according to the invention has, considered in a direction substantially perpendicular to the outer surface of the skin the formable material, a thickness, at least locally of at least 5 mm in a grip area of the grip for an optimal feel while using the appliance.

The grip area is the area of the skin of the grip where the main pressure is provided by the hand of the user while holding the grip. Often this will be a central area located at some distance from the frame.

The appliance according to the invention is defined in claim 21.

In an embodiment of the appliance according to the invention, the grip on the appliance is composed of a basic component that is covered by an additional housing or cover. Depending on the position and size of the grip, the grip may be clamped between housing and cover, mounted between housing and cover, or clicked onto either housing or cover. The best way of attaching should be chosen according to the appliance design, position of the grip and construction possibilities of the final design.

In an embodiment of an appliance comprising the grip according to the invention the grip does not stick out of the surface of the general shape too much. This means that there may need to be room to the inside of the shaver to receive a part of the grip. This has to be assessed from case to case. Preferably the grip protrudes less than 6 mm out of the adjoining remaining parts of the housing. This way the hand of the user, while holding the appliance, may contact both the grip and the adjoining parts of the appliance. This way the user has a tactile experience with both the grip and the housing, such a more complete tactile experience may increase the control over the appliance.

For appliances that are intended to be used by people with small hand it may be preferred that the grip protrudes less than 4 mm out of the housing to prevent a circumference of the appliance, in the area where the user want to hold the appliance, that is too bulky or uncomfortable to hold.

In an alternative embodiment of the appliance comprising the grip according to the invention the skin surface and the surface of the housing/cover are more or less in the same plane.

The appliance according to the invention may be any kind of appliance benefiting from the grip according to the invention. The invention is particularly suitable for a hand held appliance. The appliance preferably is a domestic appliance or a personal care appliance. The inventive measures are, however, also suitable for use in a professional environment. Examples of the latter are an electric shaver, a depilator, a toothbrush, an epilator, an iron, a coffeemaker, a vacuum cleaner, a cooker, a water kettle, a toaster, a frying pan and a hair styling device. Furthermore the grip according to the invention may be applied to the handle of for example a baby or a child cup or a baby bottle. The grip according to the invention may help the baby or young child to hold the bottle.

In an embodiment of an electric shaver according to the invention, the shaver has a shaving head fixed to a body having a longitudinal axis, the shaving head being located near one axial end of portion of the body, the shaver has a first grasp area, a second grasp area and a grip, further also mentioned as a first grip, according to the invention, wherein the second grasp area is located more in the vicinity of the shaver head than the first grasp area.

During use, the user may have his hand around the shaver, in most cases the user holds the body in the palm of his hand while steering the shaver head over the skin using thumb, index finger and probably middle finger. During use at least the thumb and index finger each are in contact with the shaver at the second grasp area. In this situation, the ball of the thumb and at least one phalanx will be in contact with the first grasp area.

In a practical embodiment the first grip is located at the first grasp area.

The first grip area may be a flank position, a back position or a front position on the body. The front position is referred to as a position on the body where the shaving head is facing. The body has two flank positions: facing the front position a left flank and a right flank position can be distinguished. The right flank and the left flank are located substantially opposite each other. The first grip mainly functions to hold the shaver in a more comfortable way and improve general control over the apparatus. In a practical embodiment the shaver comprises two first grips, one located at the left flank of the body and the other located at the right flank.

In another embodiment of the shaver according to the invention a further grip, further also mentioned as a second grip, according to the invention is located at the second grasp area. In a practical embodiment there are at least two second grips located at substantially opposite positions of the body: one on the left and another on the right. These grips function as steering positions. In this case the user is right handed the thumb steers via a right and the finger via the left second grasp area.

In another embodiment of a shaver according to the invention the first grip has a recovery time of 1.5-2.5 sec. and the second grip has a recovery time of 0.1-0.5 sec.

This way the shaver offers a firmer grip at a steering position or second grasp area a softer grip a flank position which functions to hold.

A method of manufacturing a grip according to the invention comprises the following steps:

providing a panel comprising a rigid frame, and a flexible skin having a periphery connected to frame, having an outer surface and being made from a flexible material

providing a lid,

joining the panel and the lid thereby forming a chamber with an opening,

filling the chamber through the opening with a fill material.

In practice these steps may be carried out using the following steps:

The rigid frame and the flexible skin are produced and joined in a double shot injection molded process forming a panel; double shot moulding may be over-moulding, turntable moulding or transfer-moulding,

the lid is produced in an injection molding process,

the lid and panel are combined in a watertight joining to form the chamber having an opening,

the chamber is filled with the fill material e.g. an uncured formable body gel, through the opening,

and then the uncured formable body gel is cured, f.i. at an elevated temperature, this way the fill material is transformed into the formable material.

SilGel® 612 from Wacker with a mixing ratio of component A:component B=1.5:1 is a preferred fill material. Wacker SilGel612 is a pourable, addition curing RTV-2 silicone rubber that vulcanizes to a soft silicone gel. Component B of Wacker SilGel® 612 comprises a platinum catalyst, component A a crosslinker. The curing time is highly dependant on temperature, size and heat sink properties of the component being made. In an experiment a mixing ratio of 1.5:1 resulted after curing in a preferred visco-elastic material providing a tactile experience having a comfortable grip and good steering control.

For dosing of the fill material standard laboratory or industrial dosing equipment may be used such as supplied by Rampf Dosiertechnik (Kern Liebers-group): dynamic mixing system Kern-Liebers Mixing system MK111 with dosing robot equipment DR-CNC and integrated permanent vacuum degasification.

Good results were obtained applying transfer moulding: in a first step the frame was injection moulded, in a second step the skin was moulded on the frame. In an experiment a separate machine was used in the second step.

During filling the chamber is preferably placed such that the gravity helps filling the chamber and no leaking occurs. During filling the opening is located at an upper side of the chamber.

In case the fill material is a liquid, a mixture of liquid components or a material that has a very low viscosity, it is essential that the lid provides a liquid-tight seal with the frame during filling of the chamber, so the liquid material can not run out. The filling opening for the fill material is preferably incorporated in the lid.

After step d) the opening in the chamber, this is the injection port for the gel, may be closed with a closing piece, which can be also added by injection moulding.

The formable material and the flexible skin together determine to a large extent the grip feeling experienced by the user.

A five component (5C) injection moulding process may be a way to manufacture the complete grip in one machine. This may be done as follows:
Manufacture the chamber enclosed by the skin, frame and lid (steps a, b and c as mentioned before)
fill the chamber with a cured SEBS gel,
and close the chamber with the closing piece.

Alternatively the chamber, enclosed by the skin, the frame and the lid, is manufactured in a three component (3C) injection moulding process using steps a, b and c. In a next step the chamber is filled with a non-cured gel it in a separate machine. After curing, in this case vulcanization a gel is formed.

The skin may be coated with a paint, if desired. A further aspect of the invention includes applying a low friction coating to the skin by spray coating dip coating or other suitable coating techniques.

Another aspect of the invention includes manufacturing the individual parts of the grip separately by injection moulding.

In one embodiment the thermosetting gel is injected in its liquid state and cured subsequently. In another embodiment the gel is injected in its cured state. One aspect of the invention includes bonding between lid and frame. The bonding can be of physical or chemical nature.

Yet another aspect of the invention includes the bonding of the skin to the base element. The bonding can be of chemical and/or physical and/or mechanical nature. In another embodiment lid and skin are bonded together by a sealing step. In one embodiment lid and skin are made from the same material. In one embodiment base and skin are made from a silicone material.

Alternatively the lid is shaped such that it may have two functions: lid of the grip and at the same time housing of the appliance.

The appliance tactile experience can be tuned by the choice of the materials used, the frame geometry and the general constructional design.

Another embodiment of a method of manufacturing the grip according to the invention comprises the following steps

providing a panel comprising a rigid frame, and a flexible skin having a periphery connected to the frame and having an outer surface,

placing a formable material within the periphery of the frame,

providing a lid,

joining the panel and the lid thereby forming a chamber substantially filled with the formable material.

It is noted that in EP1 419 856 assemblies having combined friction gripping and vibration damping properties for power tools are described. A gripping portion for a power tool is described where at least one vibration damping gel-containing chamber protrudes in use through part of the tool. The gripping portion described does not have a frame attached to the skin. Furthermore the invention presented in this application is not in the field of vibration damping of a tool.

The invention will now be exemplarily described with reference to the accompanying drawings and experiments. In principle all aspects can be combined. In the figures the same numbers are being used for the same or equivalent features, in which:

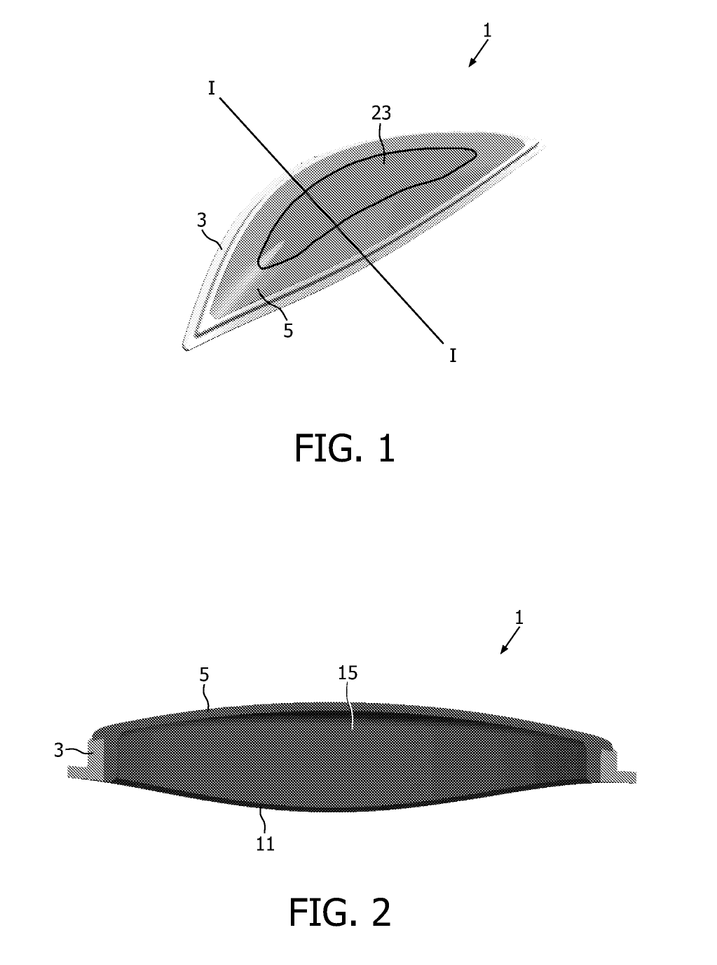

FIG. 1 schematically depicts a top view of a first embodiment of the grip according to the invention,

FIG. 2 schematically depicts a cross sectional view of the first embodiment along line I-I,

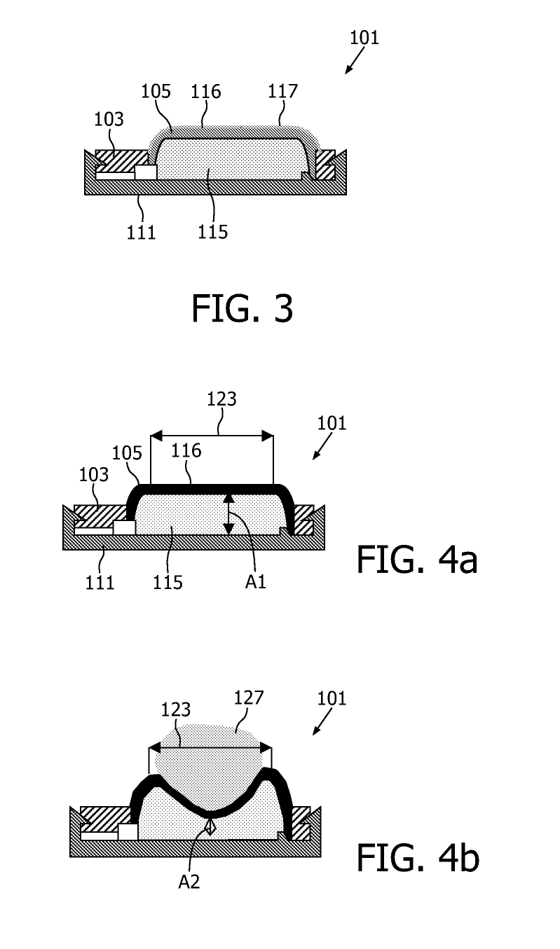

FIG. 3 schematically depicts a cross sectional view of a second embodiment of the grip according to the invention,

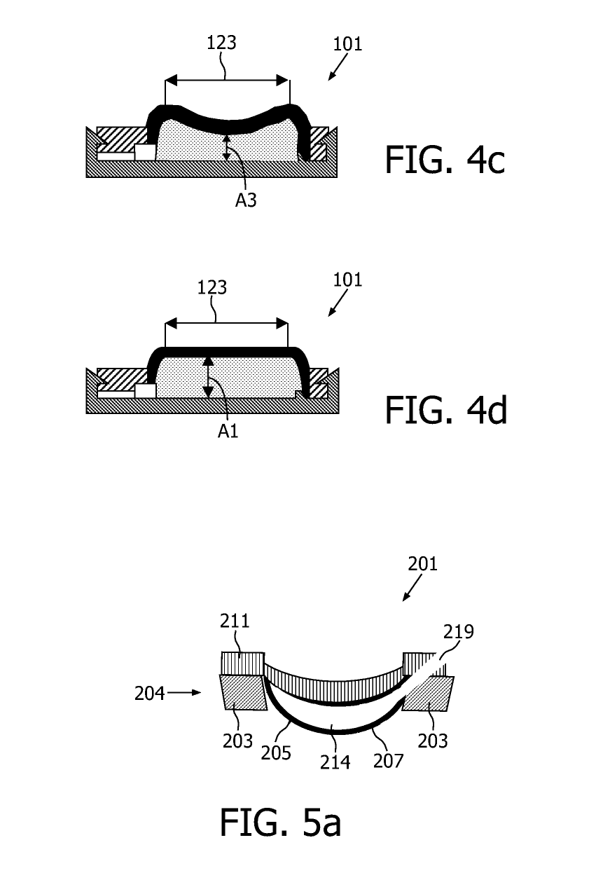

FIGS. 4a to 4d schematically depict the cross sectional view of the second embodiment at different stages in chronological order of depressed by a finger of a user,

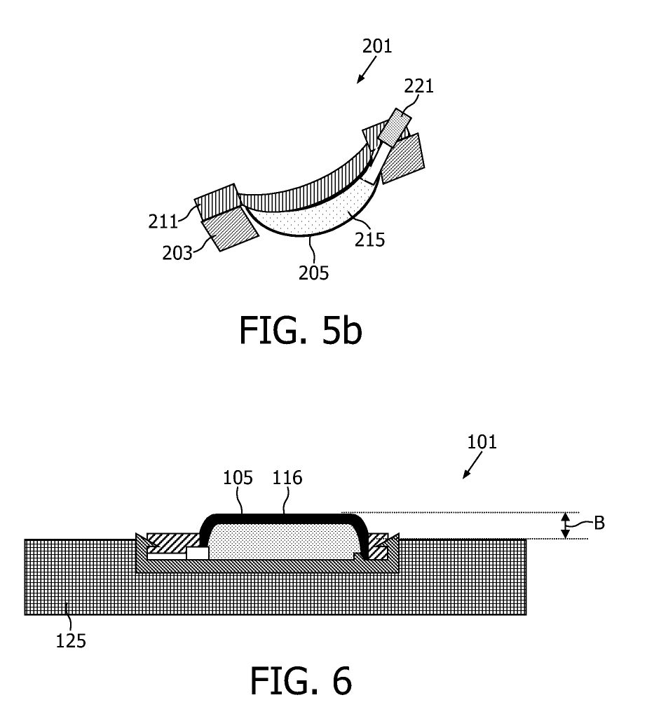

FIG. 5 schematically depicts a third embodiment of the grip according to the invention where in FIG. 5a the chamber is empty and in FIG. 5b the situation is shown where the chamber is filled with a fill material,

FIG. 6 schematically depicts a cross sectional view of the second embodiment of the grip according to the invention fixed on an appliance (shown in part),

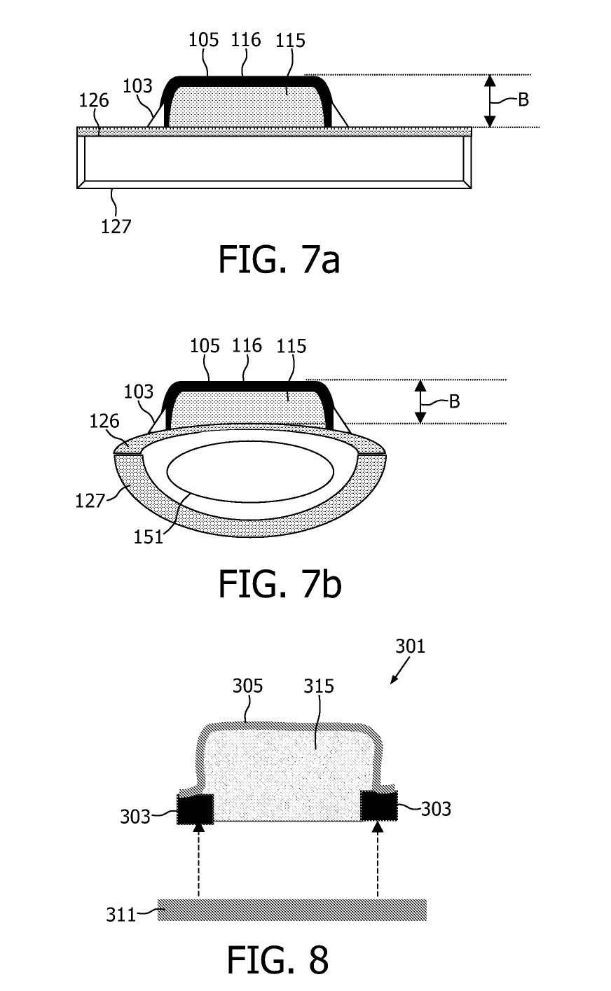

FIGS. 7a and 7b schematically depicts a fourth embodiment of the grip according to the invention where the lid forms as a part of a housing of an appliance,

FIG. 8 schematically depicts a fifth embodiment of the grip according to the invention,

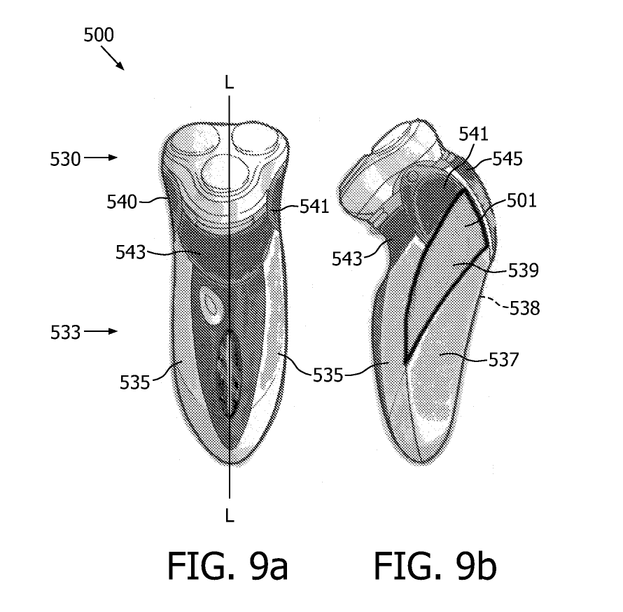

FIGS. 9a and 9b schematically depict a shaver according to the invention, wherein FIG. 9a shows a front view and FIG. 9b a flank view.

The figures are now described in detail and reference is being made to the numbers in the figures.

In FIG. 1 the first embodiment of the grip according to the invention 1 having a frame 3, a flexible skin 5 having a grip area 23 being attached to the frame at its periphery is depicted.

In FIG. 2 the first embodiment is shown in cross sectional view wherein the lid 11 is attached to the frame 3. A chamber 13 is enclosed by the skin 5 and the lid 11. The chamber is substantially filled with a formable material 15.

In FIG. 3 the frame 103 is attached to the flexible skin 105 and the lid 111 is hooked into the frame. The chamber 115 is filled with the formable material 115 and the outer surface 116 of the skin 105 is provided with a layer 117.

FIG. 4a shows the situation of the grip 101 in rest, this figure corresponds to FIG. 3. The formable material 115 has a thickness A1 of at least 3 mm in the grip area—schematically indicated in cross sectional view by arrow 123-, in a direction substantially perpendicular to the outer surface 116 of the skin 105. The thickness A1 may vary depending on the application and the design of the appliance. A handle of a water cooker for instance may comprise the grip according to the invention wherein the thickness A1 is in a range of 8-10 mm to allow a very firm grip. The thickness A1 of the grip according to the invention located on a skin care appliance such as a shaver, is preferably less than 6 mm.

FIG. 4b shows the situation of the grip 101 being depressed by a finger 127 of a user. The formable material 115 now has a smallest thickness A2.

FIG. 4c shows the situation of the grip 101 some time after the user has released the grip. In this situation the formable material 115 has a smallest thickness A3.

FIG. 4d shows the situation where the grip 101 is back to the original shape (corresponding to FIG. 4a). The formable material 115 has a again the thickness A1.

In FIG. 5a a third embodiment of the grip 201 according to the invention is shown. The skin 205 is secured to the frame 203, forming a panel 204. The lid 211 is joined with the frame. The chamber 214 is empty and has an opening 219.

In FIG. 5b a situation is shown after filling the chamber 214 with a fill material 215. The chamber is closed with stopper 221.

In FIG. 6 a cross sectional view of the second embodiment of the grip 101 according to the invention fixed on an appliance 125 (shown in part) is depicted. The outer surface 116 of the skin 105 of the grip 101 protrudes out of the adjoining remaining parts of the housing over a distance indicated by arrow B of less than 6 mm.

FIGS. 7a and 7b schematically depict a fourth embodiment of the grip according to the invention where the lid 126 has a function as being a part of the housing or cover of the appliance. The second part housing is shown very schematically at 127.

In FIG. 7b a basic component 151, depicted very schematically, is present within the housing parts 126 and 127. This basic component may comprise a motor to drive the appliance and a battery to provide the motor with power (both not shown).

FIG. 8 schematically depicts the fifth embodiment of the grip 301 according to the invention. The frame 303 is attached to the flexible skin 305 and the lid 311 is available to be joined to the frame 303. The formable material 315 is present in the cavity formed by the frame 303 and the skin 305.

FIGS. 9a and 9b schematically depict an embodiment of a shaver according to the invention, wherein FIG. 9a shows a front view and FIG. 9b a flank view.

The shaver 500 has a shaving head 530 fixed to a body 533 having a longitudinal axis L-L and a first grip 501 according to the invention.

The shaver 500 has four locations for a first grasp area. The first grasp area may be located at a flank position 539 or 538 (not shown), at a back position 537 or a front position 535.

The shaver 500 has four locations for a second grasp area: 540, 541, 543, 545. The second grasp area 540/541/543/545 is located more in the vicinity of the shaver head 530 than the first grasp area 535/537/538/539.

In a practical embodiment a first grip 501 is attached at flank location 539. A second first grip 501 is present at a flank 538 located substantially opposite flank location (location 538 is not visible in FIG. 9b, it is indicated with a dashed line).

During use, the user has his hand around the shaver, in most cases the user holds the body in a palm of his hand while steering the shaver head over the skin using a thumb, an index finger and probably middle finger. In this situation at least the thumb and index finger each are in contact with the shaver at the second grasp areas 540 and 541.

In this case the user is right handed the thumb steers via a right second grasp area 541 and the finger via the left second grasp area 540.

In this situation, the ball of the thumb and at least one phalanx will be in contact with the first grasp areas 539/538. In this case the user is right handed the ball of the thumb is in contact at the right flank first grasp area 539 and the finger at the left flank first grasp area 538.

In a practical embodiment two first grips 501 are present on the shaver, one located at the right grasp area 539 and the other at the left second grasp area 538 and both first grips have a recovery time in a range of 0.5-3.5 sec., preferably 1.5-2.5 seconds.

Good experimental results were obtained with a flexible skin made from a material selected from table 1.

TABLE 1

| | Hardness | |
|---|---|---|
| Material type | (Shore A) | Commercially available under |
| SEBS | 8 | Cawiton ® PR 6697B from Wittenburg |
| | | B.V. |
| SEBS | 15 | Cawiton ® PR 4550 |
| SEBS | 40 | Cawiton ® PR 6754B (1322-953-95086) |
| SEBS | 10 | Cawiton ® PR 5821D |
| SEBS | 20 | Cawiton ® PR 2677D |
| SEBS | 30 | Cawiton ® PR 4201C |
| SEBS | 40 | Cawiton ® PR 3935B |
| SEBS filled with | 15 | Cawiton ® PR 7138A |
| 15% talcum | | |
| SEBS filled | 15 | Cawiton ® PR 7138B |
| with 4% PTFE) | | |
| SEBS filled with | 15 | Cawiton ® PR 7138C |
| 15% glass- | | |
| particles) | | |
| SEBS filled with | 15 | Cawiton ® PR 7138D |
| 15% talcum and | | |
| an additional | | |
| additive) | | |
| TPV | 55 | Santoprene ™ 8211-55 from |
| | | Advanced Elastomer Systems an |
| | | Exxon Mobile Chemical affiliate |
| LSR | 30 | Silopren ® LSR 2730 TP 3823 from GE |
| | | Bayer Silicones, a polydimethylsiloxane |
| | | containing vinylgroups, with platinum |
| | | catalyst and inhibitors |
| LSR, | 40 | Silopren ® LSR 2740 TP 3783 from GE |
| | | Bayer Silicones, a polydimethylsiloxane |
| | | containing vinylgroups with pyrogenic |
| | | silicic acid |
| LSR | 50 | Silopren ® LSR 2750 TP 3824 from GE |
| | | Bayer Silicones, a polydimethylsiloxane |
| | | containing vinylgroups with pyrogenic |
| | | silicic acid |

The grip comprising a flexible skin made from a thermoplastic elastomer such as SEBS for example Cawiton 4550 (15ShA) from Wittenburg B.V. is preferred because the manufacturing of the parts can be done with standard injection moulding technology.

The formable material may be selected from table 2.

TABLE 2

| Material type | Commercially available under |
|---|---|
| Silicone Gel | Silgel ® 612 from Wacker |
| Poly urethane gel | Technogel, polyurethane gel e.g. |
| | Daltoped ® AF12100 and |
| | Suprasec ® 2445 both from |
| | Huntsman, hardness range from |
| | 40-80 Shore OO |
| | or |
| | Suprasec ® 2085, a high |
| | functional isocyanate reacting |
| | with Jeffox POLYOLS, a polyol |
| | both from Huntsman, hardness |
| | range from 0-60 Shore OO |
| SEBS gel | SEBS powder granulate (e.g. Kraton ® |
| (oil modified SEBS) | 1651 form Kraton Polymers) dissolved in |
| | an excess amount of paraffin oil |

The selection of the formable material and the skin material has a significant influence of the behaviour of the grip according to the invention. An embodiment of the grip comprising a flexible skin made from Silopren® LSR 2730 TP 3823 from GE Bayer Silicones and a chamber filled with SilGel® 612 from Wacker mix ratio component A:component B equals 1.5:1 and is a preferred combination. Using this combination a time of ca. 2 seconds has been measured for the grip to return back to the shape in rest after being depressed.

In case an LSR material is selected for the skin it is preferred to use a glass filled polyamide (GF-PA) for the frame, for instance Durethane® BKV140 from Lanxess GmbH (40% glass filled rubber modified polyamide 6). This material was chosen because a stiff frame was favoured combined with a good adhesion with the self-bondable silicone rubber. The adhesion between the LSR and the engineering thermoplastic improves with storage time or post curing of the material.

LNP MFX100-10MGS by GE Plastics (polypropylene filled with 10-50% glass fibres) is a suitable material to use for the frame in combination with an SEBS skin

Good results were obtained with the lid made form Terlux® 2802 Q434 from BASF (Modified ABS). Depending on material combination, curing temperature of the fill material and snap-fit requirement other suitable materials are polypropylene (PP), PP filled with glass fibres, polyamide (PA), PA filled with glass fibres, polyoxymethylene (POM) or Acrylonitrile Butadiene Styrene (ABS).

For transparent or colored lids, a transparent ABS (modified ABS or MABS) Terlux® BX13010 from BASF is a practical choice. A visually attractive depth effect is reached by high gloss chrome plating of the lid. For chrome plating, a plateable ABS may be used for instance Novodur® P2MC from Lanxess GmbH. Extra care should be taken for the construction of snap fits, because the part will be more brittle after chrome plating.

The frame is joined/snapped to the lid and preferably has a watertight join/adhesion to the soft skin layer.

The choice of material for the frame, the skin, the formable material and the lid depends on the manufacturing and/or technology. Examples of material combinations are indicated in table 3.

TABLE 3

| Frame | Skin | Formable | Lid |
|---|---|---|---|
| material | material | material | material |
| PP, PP-MF | TPV | Silicone gel, | ABS, PP, PA, |
| (mineral | | poly urethane | polycarbonate |
| filled), PP-GF | | gel, SEBS gel | (PC), |
| (glass filled) | | | polybutylene |
| | | | terephthalate |
| | | | (PBT) |
| PP, PP-MF, | TPE | Silicone gel, | ABS, PP, PA, |
| PP-GF | | poly urethane | PC, PBT, |
| | | gel, SEBS gel | POM |
| PA, PA-GF | LSR | Silicone gel, | ABS, PP, PA, |
| (glass filled) | | poly urethane | PC, PBT, |
| | | gel, SEBS gel | POM |
| ABS | TPV, TPU | Silicone gel, | ABS, PP, PA, |
| | | poly urethane | PC, PBT, |
| | | gel, SEBS gel | POM |

The polypropylene (PP) material may be replaced by other common plastics and be reinforced as well by e.g. glass fibres. PA or other carefully selected plastics like PBT are recommended when adhesion between the frame and skin is required.

Preferred material combinations are listed in table 4.

TABLE 4

| | | | | Preferred, with |
|---|---|---|---|---|
| Frame | Skin | Lid | Gel | respect to |
| PP | SEBS | PP | SEBS gel | Costs |
| PA | Silopren ® LSR | PA | SilGel ® 612 | Tactility |
| | 2730 TP 3823 | | from Wacker | |
| | from GE Bayer | | | |
| | Silicones | | | |
| PP or PP-GF or | SEBS | PP or PP-GF or | SEBS gel | Manufacturing |
| PP-mineral | | PP-MF | | |
| filled (MF) | | | | |
| PA | Silopren ® LSR | PA | SilGel ® 612 | Visual effect |
| e.g. Durethane ® | 2740 TP 3783 | | from Wacker | |
| BKV140 from | from GE Bayer | | | |
| Lanxess GmbH | Silicones | | | |

Not all material combinations for skin and formable material result in adhesion between skin and formable material after manufacturing. In case a transparent or translucent skin material is chosen, such a lack in adhesion will result in an optical effect: an air inclusion that is visible underneath the skin. Depending on the visual effect looked for this may or may not be desired.

In case the grip is intended to be free of air inclusions between the skin and the formable material a preferred material combination is Silopren® LSR 2730 TP 3823 or Silopren® LSR 2740 TP 3783 for the skin and SilGel® 612 for the formable material. In experiments these material combinations were used to manufacture the grip and the adhesion between the skin and the formable material was tested in a nail test. In the nail test an artificial nail was pressed onto the grip: directed from the outer surface of the flexible skin to the lid, thus deforming the formable body of the grip. After 20 000 of these presses no bubble formation was observed between the skin and the formable material, indicating a good adhesion.

This adhesion is especially practical is case an illumination is present in or at the grip. An air bubble, for instance resulting from poor adhesion, may scatter the light and create an unwanted darkening effect at the location of the bubble. In case a combination of transparent or translucent materials is used that results in adhesion between skin and formable material the light is distributed homogeneously out of the grip. Experiments Silopren® LSR 2730 TP 3823 or Silopren® LSR 2740 TP 3783 was used for the skin and SilGel® 612 for the formable material resulted such adhesion.

A skilled person may use alternative adhesion means to adhere skin and formable material, such as a glue.

1. A grip having
a rigid frame,
a flexible skin having an outer surface and being attached to the frame at its periphery,
a lid being attached to the frame at its periphery and
a chamber being enclosed by the skin and the lid and being substantially filled with a formable material.

2. A grip according to claim 1, characterized in that the flexible skin is made from a material selected from a group comprising silicone rubber, a thermoplastic elastomer and a polyurethane polymer.

3. A grip according to claim 2 characterized in that the flexible skin material has a hardness in a range of 5 Shore A-80 ShoreA.

4. A grip according to claim 1, characterized in that the formable material is a visco-elastic material having a storage modulus G1 in a range 1-100 kPa and a loss modulus G2 in a range 1-20 kPa.

5. A grip according to claim 1, characterized in that the visco-elastic material is an at least partially cross-linked silicone rubber, a polyurethane gel, or a SEBS gel.

6. A grip according to claim 1, characterized in that the outer surface is provided with a layer of a coating material.

7. A grip according to claim 1, characterized in that
considered in a direction substantially perpendicular to the outer surface of the skin the formable material has a thickness, at least locally of at least 3 mm in a grip area of the grip.

8. A grip according to claim 1, characterized in that the frame has a periphery shaped to fit a corresponding recess in a domestic appliance.

9. A grip according to claim 1, characterized in that the grip has a shape that after being pressed resumes its shape in rest in 0.5-3.5 seconds after release of the grip.

10. A grip according to claim 9, characterized in that the grip after being pressed returns back to the shape in rest in 1.5-2.5 seconds after release of the grip.

11. A grip according to claim 1, characterized in that the grip has a foil located in between the lid and the formable material for providing visual information or decoration.

12. Method of manufacturing a grip comprising the following steps:
providing a panel comprising a rigid frame, and a flexible skin having a periphery connected to frame, having an outer surface and being made from a flexible material
providing a lid,
joining the panel and the lid thereby forming a chamber with an opening,
filling the chamber through the opening with a fill material.

13. Method according to claim 12 characterized in that the method further comprises the following step:
closing the opening with a stopper.

14. Method according to claim 12 characterized in that the method further comprises the following step:
curing the fill material.

15. Method of manufacturing a grip comprising the following steps
providing a panel comprising a rigid frame, and a flexible skin having a periphery connected to the frame and having an outer surface,
placing a formable material within the periphery of the frame,
providing a lid,
joining the panel and the lid thereby forming a chamber substantially filled with the formable material.

16. Method according to claim 15, characterized in that the panel is manufactured by injection moulding.

17. Method according to claim 15, characterized in that the lid is manufactured by injection moulding.

18. Method according to claim 15, characterized in that the method further comprises the following step:
providing the outer surface of the skin with a coating.

19. Method according to claim 16, characterized in that the skin material is made from a material selected from a group containing a liquid silicone rubber, a thermoplastic elastomer or a thermoplastic vulcanisate, the material having a hardness in a range of 5 Shore A-80 Shore A.

20. Method according to claim 15, characterized in that the formable material is selected from a group containing silicone oil, silicone gel, polyurethane (PU) gel and highly viscous polymeric oil.

21. An appliance comprising a grip according to claim 1.

22. An appliance comprising the grip manufactured via the method according to claim 15.

23. An appliance comprising a basic component, a housing covering the basic component, a grip according to claim 1, wherein the housing is provided with the grip.

24. An appliance according to claim 23, characterized in that a part of the housing is formed by the grip and the outer surface of the skin of the grip protrudes out of the adjoining remaining parts of the housing over a distance of less than 6 mm.

25. An appliance according to claim 21, characterized in that the appliance is selected from a group containing an electric shaver, a depilator, a toothbrush, an epilator, an iron, a coffeemaker, a water kettle and a vacuum cleaner.

26. Electric shaver having a shaving head fixed to a body having a longitudinal axis, the shaving head being located near one axial end of portion of the body, having the first grip according to claim 1 and having a first grasp area and a second grasp area, wherein the second grasp area is located more in the vicinity of the shaver head than the first grasp area.

27. Electric shaver according to claim 26, characterized in that the grip is located at the first grasp area.

28. Electric shaver according to claim 27, characterized in that a further grip according to any one of the claims 1-11 is located at the second grasp area.

29. Electric shaver according to claim 28, only referring back to claim 1, characterized in that the grip has a recovery time of 1.5-2.5 sec and the further grip has a recovery time of 0.1-0.5 sec.
